(19) United States
(12) Patent Application Publication
(10) Pub. No.: US 2019/0315027 A1
(43) Pub. Date: Oct. 17, 2019

(54) EQUIPMENT AND METHOD FOR MANUFACTURING ROTOR CORE

(71) Applicant: TOYOTA BOSHOKU KABUSHIKI KAISHA, Aichi-ken (JP)

(72) Inventor: Masaki SUGIYAMA, Aichi-ken (JP)

(73) Assignee: TOYOTA BOSHOKU KABUSHIKI KAISHA, Aichi-ken (JP)

(21) Appl. No.: 16/375,528

(22) Filed: Apr. 4, 2019

(30) Foreign Application Priority Data
Apr. 16, 2018 (JP) 2018-078172

(51) Int. Cl. B29C 45/14; H02K 1/27

(52) U.S. Cl. CPC B29C 45/14; B29L 2031/34; B29C 2045/14967; H02K 1/27

(57) ABSTRACT

A rotor core manufacturing equipment used in a manufacture of a rotor core where magnets are inserted into magnet housing holes formed in a core body and a resin is supplied into the holes and subsequently cured therein. The equipment includes a stationary mold for holding the core body, a movable mold which is arranged on the core body and in which a resin flow passage is formed, and a cull plate that is arranged between the core body and the movable mold, the cull plate including a filling pot that guides the resin flowing out through the resin flow passage to the magnet housing holes and holds a cull as the cured resin. The filling pot includes an inlet which is opposite an outlet of the resin flow passage. The inlet of the filling pot has an area greater than the outlet of the resin flow passage.

### CROSS-REFERENCE TO RELATED APPLICATIONS

The present application is based on Japanese patent application No. 2018-078172 filed on Apr. 16, 2018, the entire contents of which are incorporated herein by reference.

### TECHNICAL FIELD

The invention relates to equipment and method for manufacturing a rotor core used for a motor.

### BACKGROUND ART

It is known that some rotor cores used in motor are configured that magnets are housed in magnet housing holes formed on a core body and are fixed to the core body by a resin which fills the magnet housing holes and is cured therein. When manufacturing such type of rotor core, an unwanted cured resin, which is called cull and is formed outside the magnet housing holes, needs to be removed after the resin filling the magnet housing holes is cured.

A rotor core manufacturing equipment is known which is provided with a plate-shaped member, called cull plate, which is arranged between a mold and a core body to hold culls see, e.g., JP 2014/91220 A). Providing the cull plate facilitates a cull separation step since plural culls, together with the cull plate, are separated from the core body at once when detaching the cull plate from the core body after the resin is cured. In addition, since the culls separated from the mold remain on the cull plate, it is possible to prevent poor filling or damage on the mold during the next molding process.

### SUMMARY OF INVENTION

### Technical Problem

Where the cull plate is used, a part of a resin flow path is formed in the cull plate. If the resin flow path is not precisely positioned in the cull plate and the mold, troubles such as poor resin filling or leakage of resin may occur during resin filling. However, it is not possible to avoid misalignment between the mold and the cull plate due to manufacturing tolerance of the cull plate or a stationary mold for holding the core body, and clearance (looseness) etc. Therefore, some measures are required for preventing the misalignment.

It is an object of the invention to provide a rotor core manufacturing equipment and a rotor core manufacturing method that prevent poor filling or leakage of resin during resin filling.

### Solution to Problem

According to an embodiment of the invention, a rotor core manufacturing equipment used in a manufacture of a rotor core where magnets are inserted into magnet housing holes formed in a core body and a resin is supplied into the holes to fill the magnet housing holes housing the magnets and subsequently cured therein to fix the magnets to the core body comprises:
a stationary mold for holding he core body with the magnets housed in the magnet housing holes;
a movable mold which is arranged on the core body and in which a resin flow passage is formed; and
a cull plate that is arranged between the core body and the movable mold, the cull plate comprising a filling pot that guides the resin flowing out through the resin flow passage to the magnet housing holes and holds a cull as the cured resin,
wherein the filling pot comprises an inlet which is opposite an outlet of the resin flow passage, and
wherein the inlet of the filling pot has an area greater than the outlet of the resin flow passage.

According to another embodiment of the invention, a rotor core manufacturing method wherein magnets are inserted into magnet housing holes formed in a core body and a resin is supplied into the holes to fill the magnet housing holes housing the magnets and subsequently cured therein to fix the magnets to the core body comprises:
arranging the core body with the magnets housed in the magnet housing holes on a stationary mold, arranging a movable mold with a resin flow passage on the core body, and arranging a cull plate between the core body and the movable mold, the cull plate comprising a filling pot that guides the resin flowing out through the resin flow passage to the magnet housing holes and holds a cull as the cured resin after the curing;
filling the magnet housing holes with the resin supplied via the filling pot through the resin flow passage and curing the resin filled in the magnet housing holes; and
separating the cull from the core body by removing the movable mold and subsequently detaching the cull plate from the core body,
wherein the filling pot of the cull plate comprises an inlet which is opposite an outlet of the resin flow passage, and
wherein the inlet of the filling pot has an area greater than the outlet of the resin flow passage.

### Effects of invention

According to an embodiment of the invention, a rotor core manufacturing equipment and a rotor core manufacturing method can be provided that prevent poor filling or leakage of resin during resin filling.

### BRIEF DESCRIPTION OF DRAWINGS

FIGS. 1A and 1B are diagrams illustrating a rotor core manufactured by a rotor core manufacturing equipment in an embodiment of the present invention, wherein FIG. 1A is a perspective view and FIG. 1.B is a diagram illustrating a cross section including the central axis.

FIG. 2 is a cross sectional view showing the rotor core manufacturing equipment in the embodiment of the invention.

FIG. 3 is an explanatory plan view showing how to fix a core body to a lower mold.

FIGS. 4A to 4C are diagrams illustrating a cull plate, wherein FIG. 4A is a plan view, FIG. 4B is an enlarged cross-sectional view taken along a part of line A-A of FIG. 4A and showing a portion in the vicinity of a filling pot, and FIG. 4C is a cross sectional view taken along line B-B of FIG. 4A.

FIGS. 5A and 5B are cross sectional views showing modifications of a resin accumulating portion.

FIG. 6 is a flowchart showing a procedure of a rotor core manufacturing method in the embodiment.

FIGS. 7A and 7B are explanatory diagrams illustrating a resin sealing step.

FIGS. 8A and 8B are explanatory diagrams illustrating a cull separation step.

FIGS. 9A and 9B are diagrams illustrating a modification of the cull plate, wherein FIG. 9A is a plan view and FIG. 98 is a cross sectional view taken along line C-C of FIG. 9A.

### Description of Embodiments

### Embodiment

An embodiment of the invention will be described below in conjunction with the appended drawings.

### Rotor Core

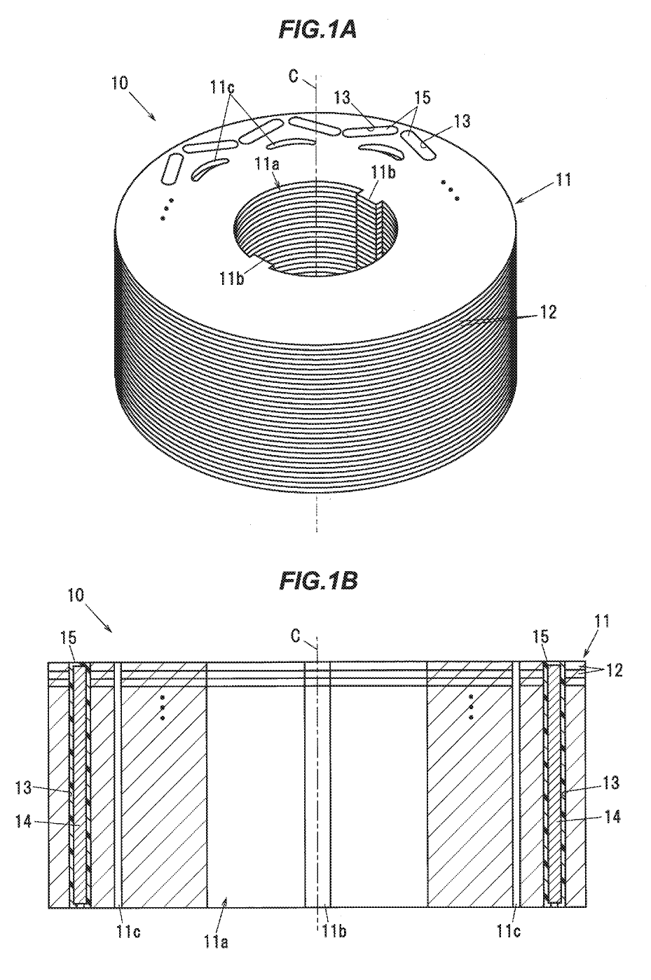

FIGS. 1A and 1B are diagrams illustrating a rotor core manufactured by a rotor core manufacturing equipment in the present embodiment, wherein FIG. 1A is a perspective view and FIG. 1B is a diagram illustrating a cross section including the central axis. As shown in FIGS. 1A and 1B, a rotor core 10 has a core body 11, magnets 14 housed in magnet housing holes 13 formed on the core body 11, and resin 15 filling the magnet housing holes 13 and cured therein.

The core body 11 is a laminated body formed by laminating plural iron core pieces 12 formed of electromagnetic steel sheet. The core body 11 has a substantially cylindrical overall shape and is provided with a center hole 11a which is formed at the center on the axis and penetrates the core body 11 in an axial direction. The central axis of the core body 11 is indicated by C in FIGS. 1A and 1B. The core body 11 has key portions 11b which are formed on an inner circumferential surface and protrude radially inward from positions facing each other. The key portions 11b are used to position the core body 11 with respect to a stationary mold 2 (described later).

The magnet housing holes 13 are formed on the outer side of the center hole 11a and penetrate the core body 11 in the axial direction. The core body 11 has plural magnet housing holes 13 which are formed at intervals in a circumferential direction. Each magnet housing hole 13 is a long oval hole of which major axis is inclined with respect to a radial direction of the core body 11, in more detail, the magnet housing holes 13 with a major axis inclined at a predetermined angle with respect to the radial direction of the core body 11 and the magnet housing holes 13 with a major axis inclined in the opposite direction at the predetermined angle with respect to the radial direction of the core body 11 are alternately formed at intervals in the circumferential direction of the core body 11.

Each magnet housing hole 13 houses the plate-shaped magnet 14 which extends along the axial direction of the core body 11. The magnet housing hole 13 is filled with the resin 15 which fixes the magnet 14 to the core body 11. As the resin 15, it is possible to use a thermosetting resin such as epoxy resin.

Cooling holes 11c for flowing a cooling medium to cool the magnets 14 are formed on the core body 11 so as to be located on the outer side of the center hole 11a and on the inner side of the magnet housing holes 13. The core body 11 has plural cooling holes 11c which are formed at intervals in the circumferential direction. Each cooling hole 11c penetrates the core body 11 in the axial direction and has an arc shape curved along the circumferential direction of the core body 11. Although it is not shown in the drawings, each cooling hole 11c has a communicating portion which is branched inside the core body 11 and is communicated with the center hole 11a.

### Rotor Core Manufacturing Equipment

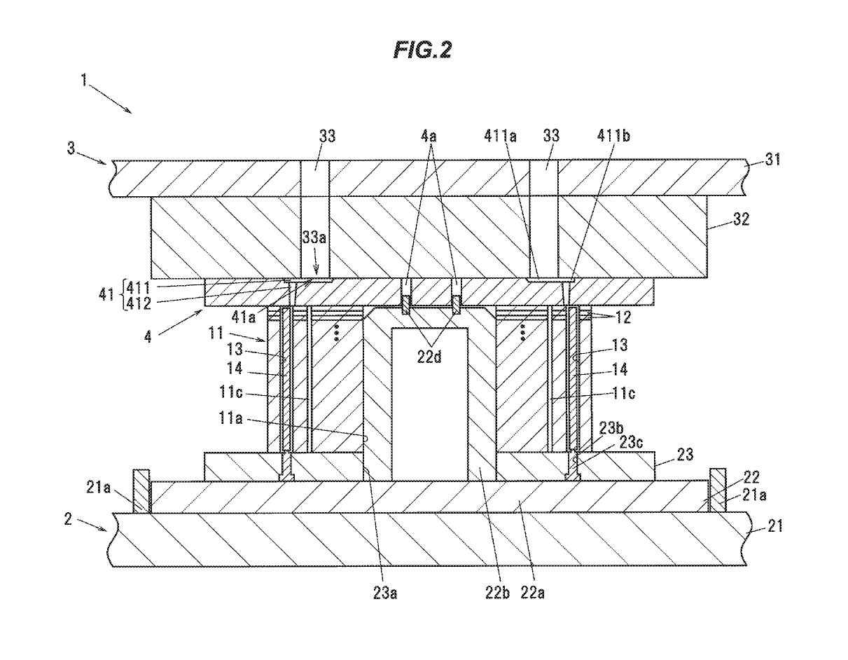

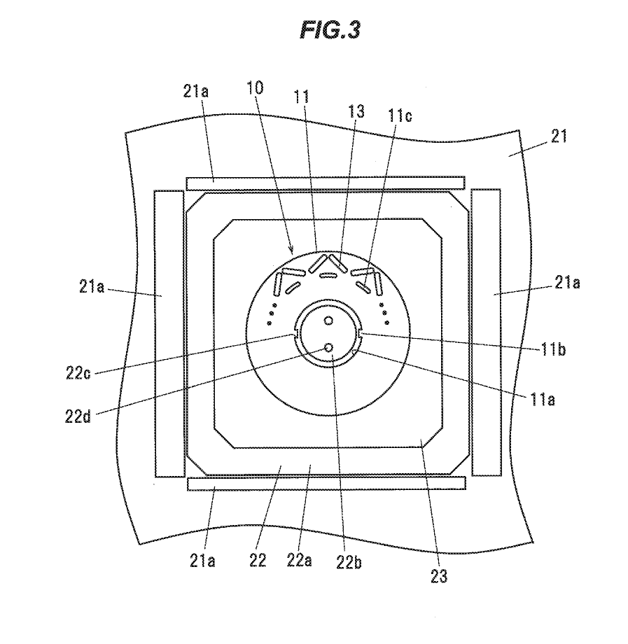

FIG. 2 is a cross sectional view showing the rotor core manufacturing equipment in the present embodiment. FIG. 3 is an explanatory plan view showing how to fix the core body 11 to the stationary mold 2. As shown in FIGS. 2 and 3, a rotor core manufacturing equipment 1 is an equipment which is operated such that the magnets 14 are inserted into the magnet housing holes 13 formed on the core body 11 and a resin is supplied to fill the magnet housing holes 13 housing the magnets 14 and is cured therein so that the magnets 14 are fixed to the core body 11. The rotor core manufacturing equipment 1 is provided with the stationary mold 2, a movable mold 3, and a cull plate 4. The movable mold 3 and the cull plate 4 are not shown in FIG. 3.

The stationary mold 2 holds the core body 11 placed thereon and having the magnets 14 housed in the magnet housing holes 13, and has a stationary mold main body 21, a support member (pallet) 22 fixed to the upper surface of the stationary mold main body 21, and a spacer 23 arranged on the upper surface of the support member 22.

The support member 22 has a plate-shaped base portion 22a having a rectangular shape in a plan view, and a substantially cylindrical post portion 22b protruding upward from the center of the base portion 22a and inserted into the center hole 11a of the core body 11. The support member 22 is detachable from the stationary mold main body 21. The support member 22 mounting the spacer 23, the core body 11 and the cull plate 4 is placed on the stationary mold main body 21.

The stationary mold main body 21 has four stoppers 21a which restrict movement of the base portion 22a in front, back, left and right directions. Although the stoppers 21a having a rectangular shape in a plan view are used in this example, the shape of the stoppers 21a can be appropriately changed. Since the movement of the base portion 22a in the front, back, left and right directions is restricted by the stoppers 21a, the support member 22 is positioned with respect to the stationary mold main body 21. In this regard, a predetermined clearance is provided between the base portion 22a and the stoppers 21a to allow the base portion 22a to be inserted between the stoppers 21a.

A pair of key grooves 22c for inserting the key portions 11b of the core body 11 are formed on the outer circumferential surface of the post portion 22b, and the core body 11 is positioned with respect to the stationary mold 2 by inserting the key portions 11b into the key grooves 22c. In addition, a pair of raised portions (pin portions) 22d protruding upward are provided at the upper end of the post portion 22b. The raised portions 22d are provided to position the cull plate 4.

The spacer 23 is formed in a plate shape and has an insertion hole 23a at the center to allow insertion of the post portion 22b. Although it is not shown in the drawings, the spacer 23 has a pair of restriction protrusions which protrude in the insertion hole 23a and are inserted into the key grooves of the post portion 22b, and the spacer 23 is positioned with respect to the support member 22 and the core body 11 by inserting the restriction protrusions into the key grooves 22c. The core body 11 is placed on the upper surface of the spacer 23 in such a manner that the lower surface of the core body 11 is in contact with the upper surface of the spacer 23.

Pin holes 23b penetrating the spacer 23 in a thickness direction are formed on the spacer 23 at positions corresponding to the magnet housing holes 13 of the core body 11, and restriction pins 23c are inserted into the pin holes 23b from below and fixed therein. The upper end portions of the restriction pins 23c protrude upward beyond the upper surface of the spacer 23 into the magnet housing holes 13 so that the magnets 14 housed in the magnet housing holes 13 are supported from below.

The movable mold 3 is arranged above the core body 11 placed on the stationary mold 2 and is separable from the stationary mold 2. The movable mold 3 has a movable mold main body 31 and a plate portion 32 fixed to the lower surface of the movable mold main body 31. The plate portion 32 is larger in outside dimension than the cull plate 4. The movable mold 3 has plural resin flow passages 33 through which a resin for sealing the magnet housing holes 13 flows in. Each resin flow passage 33 has a circular shape in a plan view and penetrates the movable mold main body 31 and the plate portion 32.

### Cull Plate 4

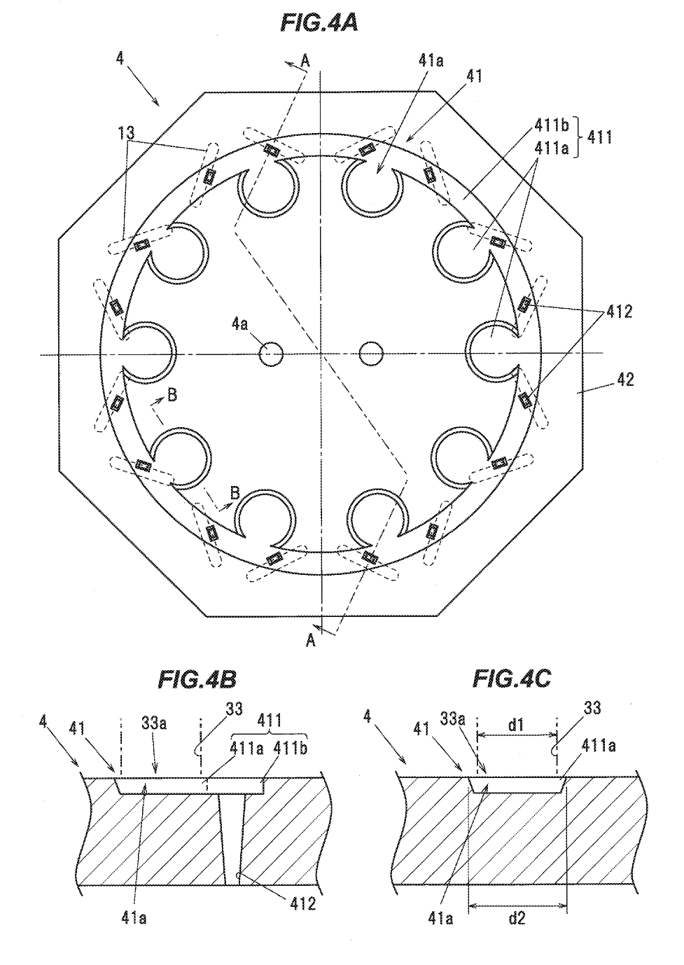

FIGS. 4A to 4C are diagrams illustrating the cull plate 4, wherein FIG. 4A is a plan view, FIG. 4B is an enlarged cross-sectional view taken along a part of line A-A of FIG. 4A and showing a portion in the vicinity of a filling pot, and FIG. 4C is a cross sectional view taken along line B-B of FIG. 4A. In FIG. 4A, the positions of the magnet housing holes 13 when stacking the cull plate 4 on the core body 11 are indicated by dashed lines. In addition, a cross section taken along the line A-A of FIG. 4A is shown in FIG. 2.

As shown in FIGS. 2 and 4, the cull plate 4 is formed in a plate shape and is arranged between the core body 11 and the movable mold 3 (the plate portion 32). The lower surface of the cull plate 4 is in contact with the upper surface of the core body 11, and the upper surface of the cull plate 4 is in contact with the lower surface of the plate portion 32.

A pair of positioning holes 4a engaging the raised portions 22d of the post portion 22b are formed on the cull plate 4. The cull plate 4 is positioned with respect to the post portion 22b and the core body 11 by inserting the raised portions 22d into the positioning holes 4a. In this regard, a predetermined clearance is provided between the raised portion 22d and the inner surface of the positioning hole 4a so that the raised portion 22d can be inserted into the positioning hole 4a.

A filling pot 41 is formed on the cull plate 4 and guides the resin flowing in from the resin flow passages 33 of the movable mold 3 to the magnet housing holes 13. Although the details will be described later, the filling pot 41 also serves to hold an unwanted cured resin called cull after the resin is cured.

Since the clearances are provided between the raised portions 22d and the inner surfaces of the positioning holes 4a and between the base portion 22a and the stoppers 21a as described above, there is a possibility that the filling pot 41 becomes misaligned with respect to the resin flow passages 33 of the movable mold 3 due to the clearances or manufacturing tolerance of each member. It is not possible to avoid such misalignment. Thus, it should be configured so that poor resin tilling or leakage of resin is prevented even when misalignment occurs.

To achieve this, in the rotor core manufacturing equipment of the present embodiment, the filling pot 41 is configured that inlets 41a receiving the resin from the resin flow passages 33 are larger than outlets 33a of the resin flow passages 33 from which the resin comes out. Thus, even when the inlets 41a of the filling pot 41 are slightly misaligned with respect to the resin flow passages 33, it is possible to introduce the resin from the resin flow passages 33 into the filling pot 41 and thereby possible to prevent troubles such as poor resin filling or leakage of resin. The area of the inlet 41a of the filling pot 41 is large enough to allow the entire outlet 33a of the resin flow passage 33 to be kept at a position facing the inlet 41a even when the cull plate 4 is offset with respect to the movable mold 3 by a maximum distance. The details of the filling pot 41 will be described below.

The filling pot 41 has a connecting portion 411 communicated with the resin flow passages 33 of the movable mold 3, and nozzle portions 412 penetrating a bottom wall of the connecting portion 411 and connecting the connecting portion 411 to the magnet housing holes 13. In the present embodiment, the connecting portion 411 has plural resin accumulating portions 411a (the same number as the resin flow passages 33) each having the inlet 41a and an annular runner portion 411b connecting the plural resin accumulating portions 411a to each other.

Each resin accumulating portion 411a has a substantially circular shape in a plan view, and the inlet 41a thereof also has a substantially circular shape in a plan view. In the present embodiment, a diameter d2 of the inlet 41a is larger than a diameter d1 of the outlet 33a of the resin flow passage 33 from which the resin comes out. The diameter d2 of the inlet 41a is desirably not less than 1 mm larger, more preferably not less than 2 mm larger, than the diameter d1 of the outlet 33a of the resin flow passage 33, even though depending on the level of manufacturing tolerance or the size of clearance to be provided. In FIGS. 4B and 4C, the resin flow passage 33 is indicated by a dash-dot line.

The resin accumulating portion 411a is tapered so that the diameter becomes smaller toward the core body 11. This facilitates removal (demolding) of the cull from the cull plate 4. The diameter of each resin accumulating portion 411a is smallest at a lower end (on the core body 11 side), and it is desirable that even the smallest diameter of the resin accumulating portion 411a be larger than the diameter d1 of the outlet 33a of the resin flow passage 33 from which the resin comes out.

The runner portion 411b is a recess-shaped groove opening upward and is formed annularly along the circumferential direction about the center of the cull plate 4 in a plan view (about the center axis C of the core body 11 when the cull plate 4 is placed on the core body 11). Each resin accumulating portion 411a is connected to the inner side of the runner portion 411b (on the side where the center of the cull plate 4 is located) and is communicated with the runner portion 411b.

The nozzle portions 412 penetrate a bottom wall of the runner portion 411b. This configuration allows the positions of the nozzle portions 412 to be freely selected regardless of the positions of the resin flow passages 33 and the resin accumulating portions 411a, and also allows the numbers of the magnet housing holes 13 and the magnets 14 to be freely selected regardless of the number of the resin flow passages 33. Thus, it is possible to improve the degree of design freedom for the rotor core 10.

Each nozzle portion 412 has a rectangular shape which has a pair of long sides parallel to a direction of the major axis of the magnet housing hole 13. In addition, the nozzle portion 412 is tapered so that the opening thereof is narrowed toward the lower side (toward the core body 11). In this configuration, a coupling portion between the resin 15 sealing the magnet housing hole 13 and the unwanted cull is thin and it is thus easy to separate the cull from the resin 15.

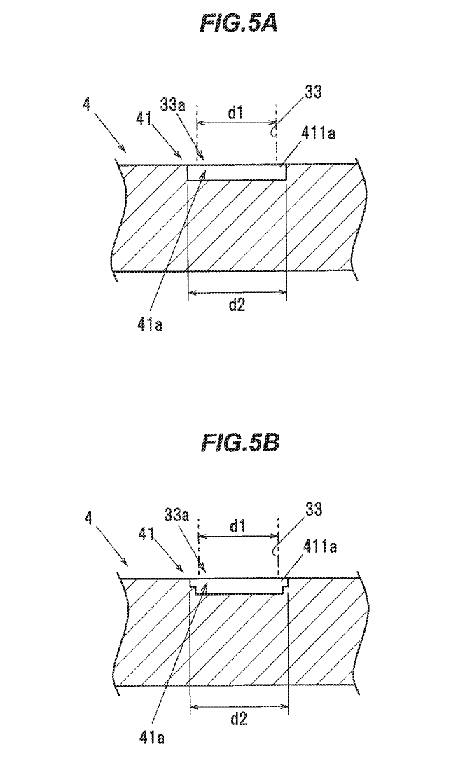

To facilitate the removal of the cull from the cull plate 4, the resin accumulating portion 411a in the present embodiment is tapered so that the diameter becomes smaller toward the core body 11. However, the resin accumulating portion 411a does not essentially need to have a tapered shape and may have a constant diameter as shown in FIG. 5A. Alternatively, the resin accumulating portion 411a may be formed so that the inner circumferential surface has a step shape with a larger diameter on the upper side, as shown in FIG. 5B. Furthermore, to facilitate the removal of the cull from the cull plate 4, the runner portion 411b may also be tapered so that the opening thereof is narrowed toward the core body 11.

### Rotor Core Manufacturing Method

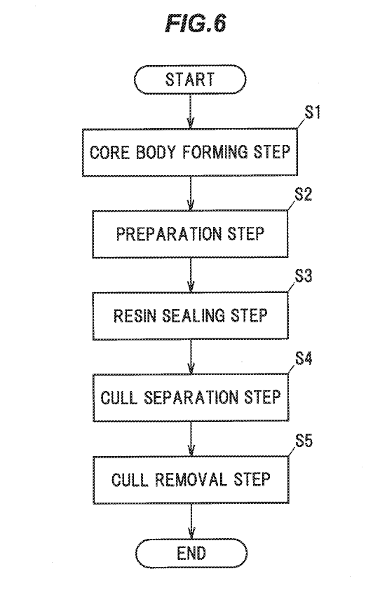

FIG. 6 is a flowchart showing a procedure of a rotor core manufacturing method in the present embodiment. In the rotor core manufacturing method in the present embodiment, a core body forming step for forming the core body 11 is firstly performed in Step S1, as shown in FIG. 6. In the core body forming step as Step S1, the iron core pieces 12 are formed by pressing electromagnetic steel sheets and are stacked, and the core body 11 is obtained by pressing the stacked iron core pieces 12 from above and below. The specific process for forming the core body 11 is not limited thereto.

Then, a preparation step for placing the core body 11 on the rotor core manufacturing equipment 1 is performed in Step S2. In the preparation step as Step S2, the core body 11 is placed on the stationary mold 2 and the magnets 14 are inserted into the magnet housing holes 13 of the core body 11. Then, the cull plate 4 and the movable mold 3 are sequentially arranged on the core body 11. The cull plate 4 used in the present embodiment has the filling pot 41 of which inlets 41a receiving the resin from the resin flow passages 33 are larger than the outlets 33a of the resin flow passages 33 from which the resin comes out. Therefore, misalignment between the outlets 33a of the resin flow passages 33 and the inlets 41a of the filling pot 41 due to manufacturing tolerance or the clearances is less likely to occur, hence, poor resin filling and leakage of resin are less likely to occur in the subsequent resin sealing step.

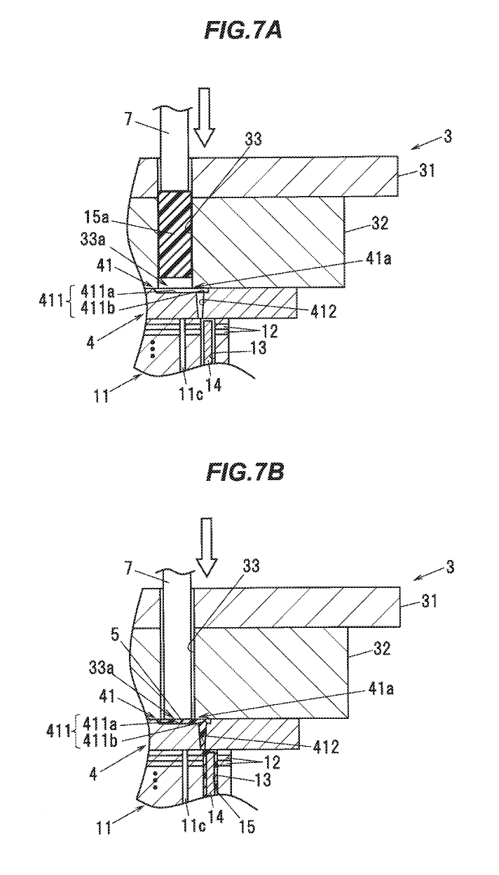

Then, the resin sealing step is performed in Step S3. In the resin sealing step as Step S3, a base material 15a, which is a thermosetting resin and is a raw material of the resin 15, is inserted into each resin flow passage 33 of the movable mold 3 and is melted by heat while pressing the material 15a downward (toward the core body 11) by a plunger 7 as shown in FIG. 7A, thereby supplying the resin (the molten base material 15a) from the resin flow passage 33.

The resin supplied from the resin flow passage 33 flows into the magnet housing hole 13 via the filling pot 41, hence, the filling pot 41 is filled with the resin as shown in FIG. 7B. Once the resin filling the magnet housing hole 13 is cured by heat, the resin 15 sealing the magnet housing hole 13 is formed and, at the same time, a cull 5 is formed in the filling pot 41 of the cull plate 4. In the resin sealing step, the core body 11 and some parts of the rotor core manufacturing equipment 1 (i.e., the support member 22, the spacer 23, the core body 11 and the cull plate 4) are pre-heated in a heating furnace and the heat in the preheating is used to melt the base material 15a and to cure the resin.

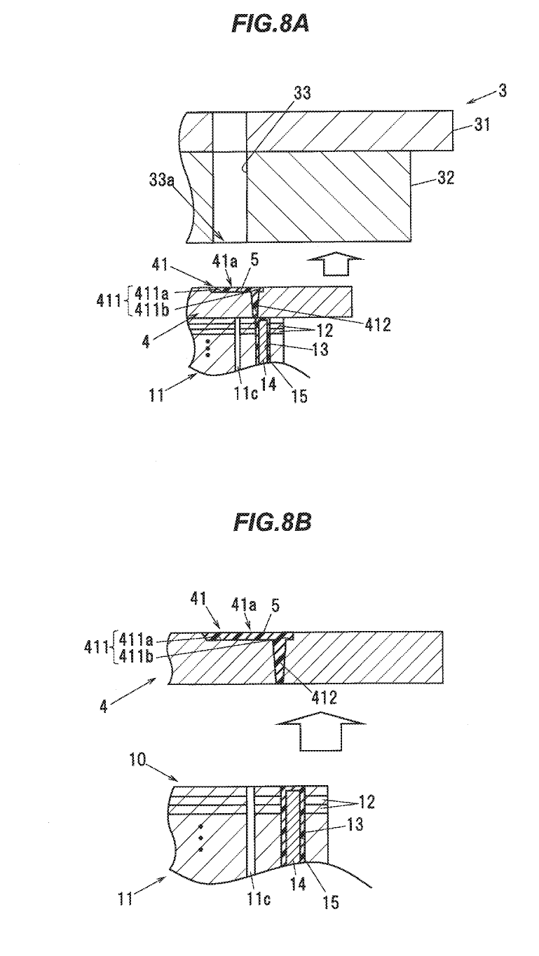

Then, a cull separation step is performed in Step S4. In the cull separation step as Step S4, the movable mold 3 is firstly removed by moving upward, as shown in FIG. 8A. Then, as shown in FIG. 8B, the cull plate 4 is detached from the core body 11. The cull 5 is thereby separated from the resin 15. The core body 11 separated from the cull 5 is then detached from the stationary mold 2, and the rotor core 10 shown in FIG. 1 is thereby obtained.

Then, a cull removal step for removing the cull 5 from the cull plate 4 is performed in Step S5. In the cull removal step as Step S5, the cull 5 is removed from the cull plate 4 by, e.g., inserting an injector pin into the nozzle portion 412 from below. However, a specific method for removing the cull 5 from the cull plate 4 is not limited thereto.

### Functions and Effects of the Embodiment

As described above, in the rotor core manufacturing equipment 1 of the present embodiment, the filling pot 41 is configured that the inlets 41a receiving the resin from the resin flow passages 33 are larger than the outlets 33a of the resin flow passages 33 from which the resin comes out. Thus, even when the cull plate 4 becomes misaligned with respect to the movable mold 3 due to manufacturing tolerance or the presence of clearances, the outlets 33a of the resin flow passages 33 can be easily kept at positions facing the inlets 41a of the filling pot 41 and it is thereby possible to prevent troubles such as poor resin filling or leakage of resin during the resin sealing step.

Also, since increasing the size of the inlet 41a of the filling pot 41 makes an edge portion around the outlet 33a of the resin flow passage 33 less likely to be in contact with the cull plate 4, it is also possible to prevent damage on the edge portion of the resin flow passage 33 due to the contact with the cull plate 4. The inner circumferential surface of the resin flow passage 33 sometimes has a hard, brittle structure for the purpose of improving abrasion resistance. In the present embodiment, damage on the movable mold 3 can be prevented even when the inner circumferential surface of the resin flow passage 33 has a hard, brittle structure.

Furthermore, since increasing the size of the inlet 41a of the filling pot 41 allows the resin to flow around the plunger 7 even when the plunger 7 is lowered until coming close to the cull plate 4 or until an end portion thereof protrudes into the filling pot 41, it is possible to prevent a trouble such as a failure of the molten resin to reach the nozzle portion 412 due to being blocked by the plunger 7.

Although the embodiment the invention has been described, the invention according to claims is not to be limited to the embodiment. Further, please note that all combinations of the features described in the embodiment are not necessary to solve the problem of the invention.

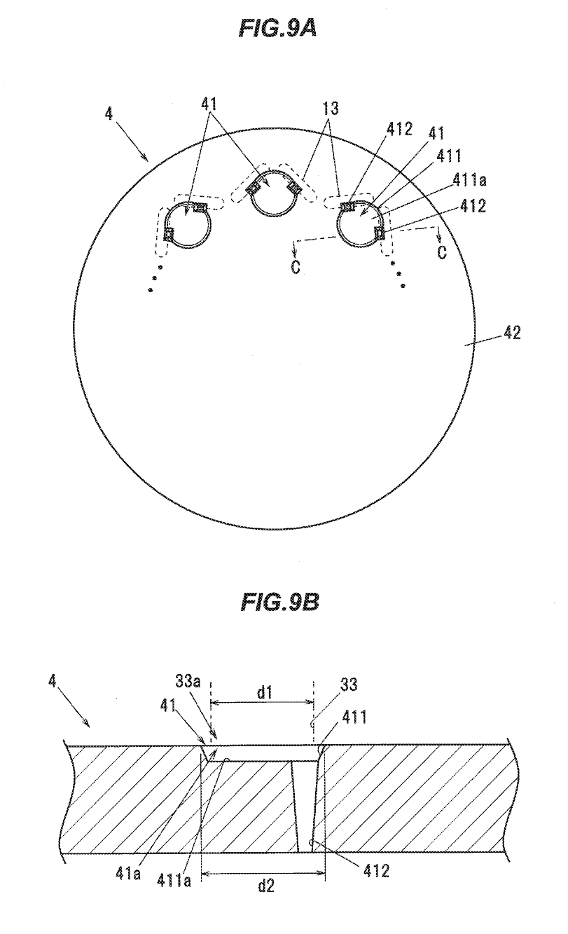

The invention can be appropriately modified and implemented without departing from the gist thereof. For example, although the connecting portion 411 is composed of the resin accumulating portions 411a and the runner portion 411b in the embodiment, it is not limited thereto. The configuration may be such that the runner portion 411b is not provided and the nozzle portions 412 are formed to penetrate the bottom walls of the resin accumulating portions 411a, as shown in FIGS. 9A and 9B.

1. A rotor core manufacturing equipment used in a manufacture of a rotor core where magnets are inserted into magnet housing holes formed in a core body and a resin is supplied into the holes to fill the magnet housing holes housing the magnets and subsequently cured therein to fix the magnets to the core body, the equipment comprising:
a stationary mold for holding the core body with the magnets housed in the magnet housing holes;
a movable mold which is arranged on the core body and in which a resin flow passage is formed; and
a cull plate that is arranged between the core body and the movable mold, the cull plate comprising a filling pot that guides the resin flowing out through the resin flow passage to the magnet housing holes and holds a cull as the cured resin,
wherein the filling pot comprises an inlet which is opposite an outlet of the resin flow passage, and
wherein the inlet of the filling pot has an area greater than the outlet of the resin flow passage.

2. The rotor core manufacturing equipment according to claim 1, wherein the area of the inlet of the filling pot is set such that the entire outlet of the resin flow passage is kept opposite the inlet of the filling pot even when the cull plate is offset with respect to the movable mold by a maximum distance.

3. The rotor core manufacturing equipment according to claim 1, wherein the inlet of the filling pot and the outlet of the resin flow passage are formed circular in a plan view, and a diameter of the inlet of the filling pot is larger than a diameter of the outlet of the resin flow passage.

4. The rotor core manufacturing equipment according to claim 1, wherein the filling pot comprises a connecting portion communicated with the resin flow passage of the movable mold and a nozzle portion penetrating a bottom wall of the connecting portion and connecting the connecting portion to the magnet housing holes,
wherein the connecting portion comprises a plurality of resin accumulating portions each comprising the inlet and an annular runner portion connecting the plurality of resin accumulating portions to each other, and
wherein the nozzle portion penetrates a bottom wall of the runner portion.

5. The rotor core manufacturing equipment according to claim 4, wherein the resin accumulating portion is tapered so that the diameter becomes smaller toward the core body.

6. A rotor core manufacturing method wherein magnets are inserted into magnet housing holes formed in a core body and a resin is supplied into the holes to fill the magnet housing holes housing the magnets and subsequently cured therein to fix the magnets to the core body, the method comprising:
arranging the core body with the magnets housed in the magnet housing holes on a stationary mold, arranging a movable mold with a resin flow passage on the core body, and arranging a cull plate between the core body and the movable mold, the cull plate comprising a filling pot that guides the resin flowing out through the resin flow passage to the magnet housing holes and holds a cull as the cured resin after the curing;
filling the magnet housing holes with the resin supplied via the filling pot through the resin flow passage and curing the resin filled in the magnet housing holes; and
separating the cull from the core body by removing the movable mold and subsequently detaching the cull plate from the core body,
wherein the filling pot of the cull plate comprises an inlet which is opposite an outlet of the resin flow passage, and
wherein the inlet of the filling pot has an area greater than the outlet of the resin flow passage.
